(19) United States
(12) Patent Application Publication
(10) Pub. No.: US 2005/0055373 A1
(43) Pub. Date: Mar. 10, 2005

(54) Determining point-of-compromise

(76) Inventor: George H. Forman, Port Orchard, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/654,821

(22) Filed: Sep. 4, 2003

(51) Int. Cl. G06F 17/00

(52) U.S. Cl. 707/104.1

(57) ABSTRACT

A data mining and knowledge discovery method and system. A data base is established in a virtual matrix form for each transaction of large scale transactional events. Data is filed and logged in a manner for rapid sorting such that given a set of identifiers for comprised transactions, a limited subset of the matrix only need be accessed for specific knowledge discovery in the nature of point-of-compromise. For each potential point-of-compromise, a tally is compiled. Potential points-of-compromise are sorted according to tally score. Score is indicative of increasing likelihood of a source point-of-compromise.

### BACKGROUND

1. Technical Field

This disclosure relates generally to computer data storage, data mining and knowledge discovery. More particularly, the disclosure relates to determining relationships in order to find a probable point-of-compromise from a correlated database of interactions of members therein from patterns and relationships in the data.

2. Description of Related Art

Along with the processing power of modern computers has come the amassing of digital data into databases having sizes which tax reasonable data storage limits and computing power, the ability to derive meaningful conclusions from the data in a prompt, or “real-time,” manner. Fast computer memory such as random access memory integrated circuits are relatively expensive for use as massive databases; the use of mass data storage apparatus, such as electromagnetic tape or electro-optical disk drives, are far more economical but have attendant significant compromises with respect to the access time to data. Yet within such massive databases lies information which can be of strategic importance.

For example, consider the simple problem of credit card, and debit card, fraud. A loan service or clearinghouse service company, such as Discover™, Mastercard™, Visa™, or the like, licenses its logo to a plurality of lending institutions which then issue individual credit cards; each transaction processed is funneled through the company. A miscreant employee occasionally steals customer credit card numbers and identification and later sells them on the Internet. A cloned card may complete several fraudulent transactions before the problem is recognized and the card is cancelled. With the enormous number of worldwide authorized merchants, credit cards, and credit card transactions per day, determining where the originating card theft likely occurred, the point-of-compromise, is a seemingly impossible task. Even repeated offenses at a specific merchant site are unlikely to be discovered easily or quickly, because the card numbers stolen are distributed among different card issuers and no fraudulent transactions are necessarily committed at the actual point-of-compromise. By avoiding any simple patterns like stealing only “Ajax Credit Cards,” the thief hopes to thwart each individual issuer.

With there being an enormous number of credit card payment transactions on each issuer's cards on a daily, or even hourly, basis, tracking each transaction and attempting to determine a probably point-of-compromise from bogus transactions is likely an impossible task without the aid of computer data storage and data mining. Yet even with modern computing power, there are problems. For example, given a worldwide set of ten million merchants and a set of five hundred million credit card holders, to log a simple correlation of each credit card use to each merchant identification in a brute-force dense format, e.g., where one bit in a two-dimensional memory matrix designates a transaction, would require approximately 568 terabytes—568,000,000,000,000 bytes—of storage. Thus, the data compilation task for a single credit card company becomes unwieldy.

Moreover, the point-of-compromise may not even be a particular merchant's employee. For example, merchants at a mall may combine computer terminal operations through a transaction aggregation server for the entire mall provided by each credit company, card issuer or conglomerate of issuers. That is, each checkout register is merely a terminal for a mainframe computer located somewhere other than at the specific merchant given an individual identifier. A hacker may compromise the mainframe and steal credit card information. Similarly, the problem is exacerbated greatly by Internet commerce which relies heavily on credit transactions and where a Web site, such as that of a merchant or an escrow service, can be compromised by a hacker.

Another example of a need for determining possible point-of-compromise would be for products which may see a plurality of uses and users over time, e.g., portable medical equipment.

Still another example for point-of-compromise determination problem relates to original equipment manufacturers having worldwide mass distribution channels, such as integrated circuit “chip” manufacturers. A manufacturer may have ten machines fabricating hundreds of thousands or even millions of chips of a particular design which are then distributed all over the world via an appliance manufacturer having a global installed base, e.g., chips in cellular telephones. If at some later time a significant chip hardware problem arises in the installed base, the manufacturer may need to determine which of the ten machines and which particular runs producing the potentially defective chips still in service are affected in order to contact users such as for a for a recall. Chip serial numbers must be correlated to machines and particular time-stamped runs for each chip yield of the machines to find a potential point-of-compromise. Other mass market distributed items of manufacture having user-critical characteristics, like other computer-related consumables such as inkjet cartridges, sterile medical and surgical supplies, sealed-package foods, and the like, produced on a variety of machines at a plurality of locations may carry the same problem of identification of the specific source of a defect.

In the state of the art, the only practical and economical data storage is mass data storage apparatus. Where time is of the essence, for example where a credit issuer is sustaining bogus credit card transactions hourly with limited liability for reimbursement from the card holder, fraud costs significantly affect the cost of doing business. Yet access to the data may mean serially searching a library-like storage room filled with back-up data tapes of serially-logged transaction records. Finding every transaction for a specific card over a specific time frame prior to the start of fraudulent use in order to try to identify the origination of the fraud—e.g., the merchant having the felonious employee—is like finding a veritable needle in the haystack. Clearly, the situation worsens with the unknown factor of time delay the thief may have used to mask the initial time of each theft. It can thus be recognized that rapid access to meaningful information in such massive data bases within a relatively rapid time frame is an important and significant task.

There is a need for solving such data mining, knowledge discovery tasks with minimal processing power and data storage requirements.

### BRIEF SUMMARY

The basic aspects of the invention generally provide for a data storage and data mining for detecting a possible point-of-compromise.

Aspects of the invention are described with respect to exemplary embodiments associated with the problem of credit card fraud.

The foregoing summary is not intended to be inclusive of all aspects, objects, advantages and features of the present invention nor should any limitation on the scope of the invention be implied therefrom. This Brief Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1 in accordance with an exemplary embodiment of the present invention is a chart illustrating a matrix structure for logging transactions.

FIG. 2 is a flow diagram illustrating storing of data relevant to point-of-compromise in accordance with an exemplary embodiment of the present invention as shown in the embodiment of FIG. 1.

FIG. 3 is a flow diagram illustrating a specific exemplary embodiment for implementing point-of-compromise determination in accordance with the embodiments of FIGS. 1 and 2.

FIG. 4 is a flow diagram illustrating a generic implementation for point-of-compromise data storage and data mining in accordance with the embodiments of FIGS. 1 and 2.

Like reference designations represent like features throughout the drawings. The drawings in this specification should be understood as not being drawn to scale unless specifically annotated as such.

### DETAILED DESCRIPTION

The present invention is described herein by continuing the Background section description of credit card fraud as a significant exemplary implementation. This is merely to facilitate understanding of the invention which is applicable to any commercial transaction or industrial operation situations where a very huge number of individual events need to be logged into a useful database; no limitation on the scope of the invention is intended by the inventors nor should any be implied therefrom. The scope of the invention is set forth by the claims hereinbelow.

Turning now to FIG. 1, assume as an example that a fictitious company, Ajax Credit Company, licenses a plurality of banks, or other issuers, to issue a million credit cards, “CC_{1 through H},” where “H”=last cardholder identifier, each credit card having a unique alphanumeric-like identifier, e.g., a sixteen digit number. Ajax signs on several million merchants, “M_{1 through S},” where “S” is the last authorized Seller, to accept the Ajax logo'd credit cards for transaction payment. A matrix of card identifiers versus merchants can be formed by Ajax, or its designated agent or associated business for tracking individual card usage. Clearly, the number of cards issued and accepted and the number of authorized merchants can change significantly on a monthly, weekly, daily, or other given time frame. The company can decide a specific significant time frame for logging data based on the particular implementation criteria involved.

It will be recognized by those skilled in the art that for each transaction the stored data can be minimized. A pair of identifiers, (MERCHANT, CARD) in seven bytes of data suffices, where four bytes are enough to address 4.3 billion credit card holders (30 bits per billion) and three bytes are enough to address 16 million merchants.

To minimize memory requirements, the minimal amount of information is used to construct a matrix 100. As shown in FIG. 1, a simple two-dimensional merchant, card—Mᵢ, Cᵢ—data pair matrix is used to record each transaction. Note that for other implementations more complex three-plus dimensional matrices may be employed. Each transaction between a cardholder and a merchant is correlated with a one-bit 101 in the matrix 100; e.g., a digital “1” at memory location M₁,CC₂, 101 signifies a transaction, or “hit.” Computer automation of filling “hits” in the matrix for each predetermined time period would be known to those skilled in the art.

Given such a matrix, or more likely for example, a set of daily or weekly matrices that cover a set of time frames, the computer can scan for each given compromised credit card number and extract those merchants having had a transaction, whether bona fide or bogus, with each of said credit cards. Note that the date-range employed for each card number may vary. That is, e.g., one card may have been compromised a year ago and another card may have been compromised yesterday; the scan date-range of the past, or “past window,” for each card is tailored accordingly with respect to each date first known that the card has been compromised, at some unknown time in the past.

Referring specifically to FIG. 1, assume credit cards CC₂, CC₃ and CC_{H-1} are reported, or otherwise determined, as being compromised. Scanning down the column 103 for compromised card CC₂ would extract merchants M₃ and M_{S-1}. Scanning down the column 105 for compromised card CC₃ would extract merchants M₂, M₃ and Mₛ. Scanning down the column 107 for compromised card CC_{H-1} would extract merchants M₁, M₃ and Mₛ. The “hit” score for each listed merchant is tallied:
M₁=1
M₂−1
M₃=3
Mₛ₋₁=1
Mₛ=2.
   The score being the highest for merchant M₃ rates the highest probability for being a probable point-of-compromise for the given set of compromised credit cards; merchant Mₛ rates the next highest probability, and merchants M_{1, 2, s-1} rate the lowest probability. In other words, since it is likely that a malfeasant employee has compromised a plurality of credit cards, finding the merchant where the most number of compromised cards have been used is a good predictor of where the felonious activity has occurred.

Many known manner matrix database building and manipulation commercial products from Microsoft, Oracle, Sybase, and the like are known in the art. Further description is not necessary for an understanding of the present invention. Moreover, many mathematical abstraction techniques are known in computer science for analyzing statistical data, e.g., matrix, sparse matrix, Logfile, B-Tree, and the like may be adapted for data analysis, and further description is not necessary herein.

Keeping and manipulating a full matrix where many millions of authorized merchants may be serviced by the credit card issuer and many times more millions of cards may have been issued, keeping a complete matrix on even a daily basis would have very large hardware storage requirements. Furthermore, an enormous table of information showing data related to every transaction is inefficient to process. Thus, in the preferred embodiment, in order to reduce the memory and data retrieval requirements, hashing the data (using representations of data, also referred to as “keys,” to store and retrieve data) using modulo N arithmetic is employed where N=256 when creating time logged files. For example, in the logging computer, on a daily basis, 256 separate files are opened, wherein each file contains a portion of the entire days logged transactions. It will be recognized by those skilled in the art that technical progress and affordability in technology computer storage and data processing would allow 256ⁿ files, greatly increasing the power of the algorithm described herein. More specifically as an example, the credit card number columns in FIG. 1 are divided into 256 groups. All transaction bits which belong to the first group are logged in the first file, all transaction bits which belong to the second group are logged in the second file, and so on for all 256 groups. Thus a resulting collection of identified objects, namely transaction “hits” in a specific group have the same type of identifying structure. In other words, using modulo N arithmetic, a file may contain all transactions related by, for example, the last digit of a plurality of cards, namely all issued cards with their 16-digit numbers ending in 3“C_{. . . 3}” that had at least one authorized merchant transaction logged on that day. Moreover, the “3” need not be stored repeatedly in the file, also saving storage space and processing time. As will be recognized by those skilled in the art, a variety of such hashing techniques, parallel processing, and other known manner data storage techniques may be employed for organizing such an intrinsically large database into a manageable files and optimizing computing power.

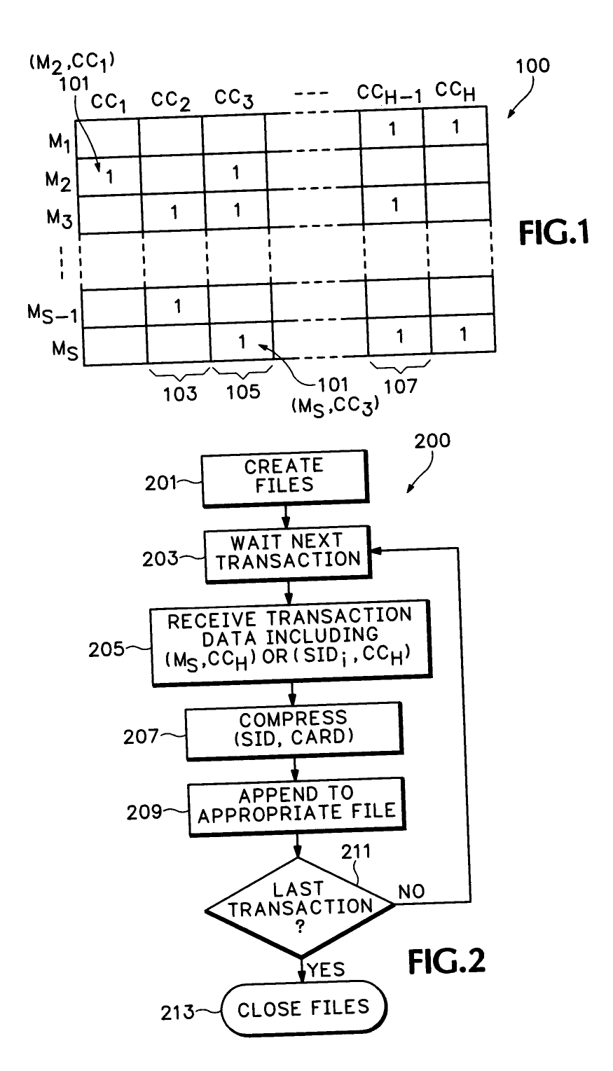

FIG. 2 is a process 200 flow diagram illustrating the applicable storing of data in accordance with a specific exemplary embodiment of the present invention related to a credit card database and credit card fraud. As mentioned above, a brute-force matrix storage and scanning for every hit can be implemented, but only with great disadvantages as to required storage space and microprocessor input-output functions. Therefore, data storage and processing time should be optimized.

Assume that the credit card issuer Ajax keeps daily log files for each transaction involving an issued Ajax credit card. In accordance with the preferred embodiment, for each twenty-four hour period—e.g., starting 12:00 a.m. Greenwich Mean Time (“GMT”)—Ajax, or his agent such as a business associate assigned the task of tracking credit card fraud, creates 256 new files, 201. The issuer then waits, 203, to receive data for each transaction. Each transaction will be received, 205, and include the credit card number and a merchant identification where each merchant had received a unique identifier, “Ms.”

Here it is useful to consider the situations described in the Background section where issues in the installed-base field—such as merchants with like names, merchants such as large department stores with hundreds of terminals, merchants changing computer systems or aggregation services, many Web sites belonging to a single merchant, or the like—can create misdirection during data analysis or at least less accurate data for pinpointing a point-of-compromise. Each entity merchant, terminal, aggregator, or the like, preferably is tracked; each may therefore constitute another row, or column, of a credit card transaction data storage matrix. It is also preferred that instead of logging just merchant numbers, that an abstraction of “Situation Identifiers” (“SID”) may be established; in other words, to reduce storage and process requirements, a unique SID is assigned to multiple entities which are related. For example, given SID₂₀₃=NJPMAT48 may represent the physical “New Jersey Paramus Mall Aggregator: Terminal 48” which is known to be in Macy's Department Store in that same mall. Note also, that given further information about SIDs established for entities originally, e.g., Borders Books NYC, and Borders Books 10002, later being determined to be the exact same physical location store entity, may allow for condensing data and future transactional data. In effect, multiplexing entities with an SID permits updating cumulative data storage in a simpler manner than trying to update a simple, linear, transaction-by-transaction data listing. Each change to the macro-system requires assigning a new SID in order to track the different configuration separately. Then, at time of tally, each SID extracted can be correlated to one or more related merchants, aggregations, computer terminals, or the like, implicated. It is preferred that each transaction include a relational data pair structured as: (SIDᵢ, CC_{H}) and a separate database correlating SIDs to a list of entries.

Preferably, each data pair is manipulated 207 to compress storage and sorting requirements. Let the last byte be used to group credit cards CC_{. . . 0}, CC_{. . . 1}, CC_{. . . 3} through CC_{. . . 9} for purposes of data sorting. That is, a file is created for all cards ending in “0000 0000” binary, another file for all cards ending in “0000 0001” binary, et seq. For example, as a credit card generally has a unique 16-digit number, storing each complete number is memory extravagant. The last digit, 8-bits, lowest order byte of the card number is split out into an 8-bit variable file number and the remaining bits are a “rest” variable. In a known manner, the notation is thus:
(filenoᵢ, restᵢ)=split(cardnoᵢ).
   For data storage purposes, for each specific transaction a data pair (restᵢ, SIDᵢ) is appended 209 to the file number and stored accordingly in the appropriate one of the 256 opened files.

At the last recordable transaction of the logging day, e.g., it is now 12:00 a.m. GMT of the next day, 211, YES-path, the files are closed 213 and identifiably marked for retrieval accordingly, such as in a known manner of date/time-stamping. If the last transaction was not the last recordable transaction of the day, the process loops to the wait state 203.

Appending to files of a database is well known in the art, commonly referred to as opening files in an “append mode.” New files or new databases may be created based on other time periods—e.g., closing a database at the end of each day, month, or other given time period. When analyzing the data later, many files are eliminated as irrelevant to particular compromises simply by their date information. Therefore, maintaining a time-based storage of all interactions may be implemented in accordance with the needs of any specific implementation. Generally then, in such a manner, Ajax has a set of manageable files and can find relevant, segregable, time windows, from what is likely to be millions of actual past transactions. Each file is associated with a common structure or characteristic of the matrix-resident identifier, such as a last digit or data byte for issued credit cards. At some later time then, namely, once a compromised card number is known, only the files associated with that structure or characteristic need be searched and the associated data pair identifiers, namely the correlated SIDs, need be retrieved and tallied. Again, from their tally score, a point-of-compromise origin can be predicted.

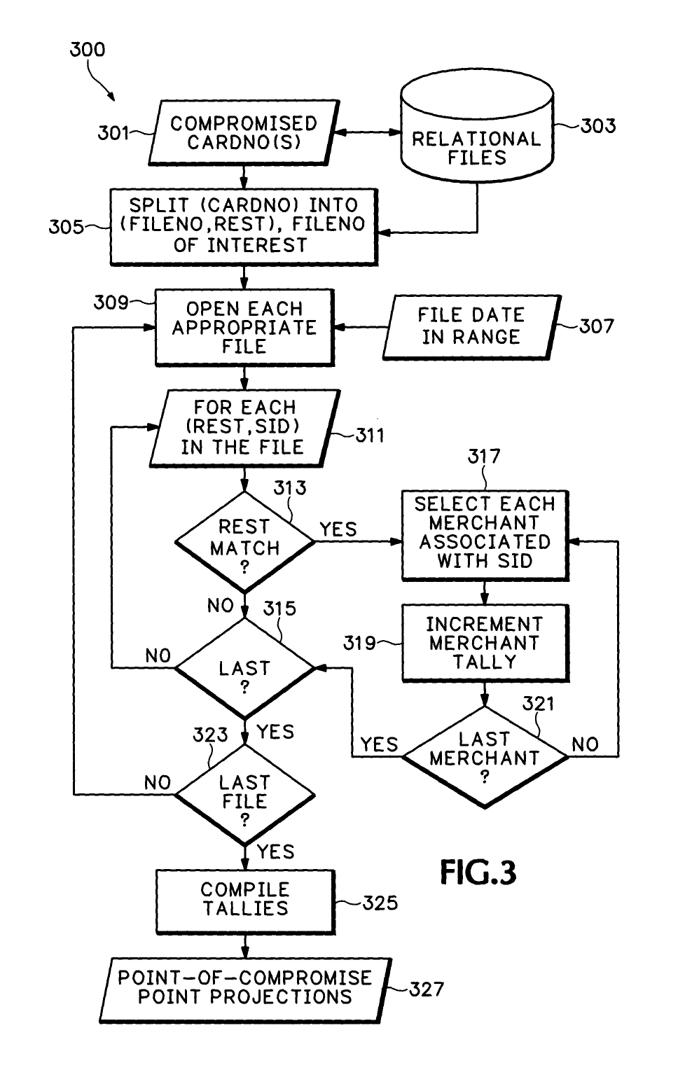

FIG. 3 is an exemplary embodiment for implementing the point-of-compromise estimation procedure 300 generically. At some point in time it becomes apparent to the user that a system-of-interest—the Ajax Credit Co. system, the installed base of defibrillators, the identification code for a set of consumable products, or the like—has been compromised at an unknown fraud origination point, or points, involving more than one specific item.

Continuing the Ajax Credit Co. credit card system exemplary embodiment, assume that several credit card numbers have been stolen; therefore, there is a set of known unique compromised credit card numbers 301. For each specific compromised credit card number, cardnoᵢ, there is a related file 303 as described with respect to FIG. 2.

Ajax can collect, or maintain, a relational list of credit card numbers, “cardno,” for each file number, “fileno.” Files not associated with a compromised credit card number are immediately eliminated from being a suspected point-of-compromise since there will be no relevant transaction data in those files. Thus, the Ajax Credit Co. quickly extracts only those files related, namely those files having one or more compromised card numbers. In other words, from a collected list of credit card numbers for each file, those files having a non-empty list with respect to the set of compromised cards, or files true “hits,” are now the only files-of-interest. Each relevant extracted file (if coincidently all compromised card numbers are in a single file) or files 305 will be separately considered serially or iteratively

By definition, each transaction will have a given timestamp. Only a predetermined date range will be of interest to Ajax. For example, the first compromised card transaction may have occurred yesterday, a second compromised card two months ago, or all of the compromised cards currently under consideration may have been reported only within the last week. However, if related, the actual point-of-compromise problem may have occurred previously; e.g., a malevolent employee may have begun stock-piling stolen credit card numbers months in advance of his sale of them. Therefore, the user should want to use a predetermined date range much greater than just going back to the first date of compromise, e.g., going back to look at all transactions of each compromised card for one year prior to that particular cards first known compromise date. The further back in time one searches, the more likely the tabulation will cover the point-of-compromise; a reasonable range-of-interest will be dependent upon the specific implementations predetermined data domain knowledge. Therefore, each file 303 is opened 309 that has its file number, “fileno,” and its date with the range-of-interest 307.

Each opened file 305 will contain many more records of card transactions than those associated with the compromised cards 301. Therefore, it is necessary to extract only matching “hits” for the compromised cards 301. This may be done by looping through the files recording the (rest, SID) specific transaction pairs 311 described hereinabove and making a determination 313 whether the restᵢ matches any restᵢ in the comprised set 301, 305. Each pair in the open file is scanned 315, 313. For each match 313, YES-path, each entity, for the purpose of a compromised credit card an exemplary authorized merchant entity (Ms, FIG. 1) is identified 317. In other words, a compromised card on the list has been correlated to a specific merchant and a specific transaction of the virtual matrix. Therefore, it is appropriate to keep a relational score as described above. That merchant is assigned to the compromised card “hit” tracking dataset; the tally for that merchant is incremented 319 for each “hit” in each SID for the current card, “rest.” A check 321 is made for other “hits” on the same merchant (e.g., at a different register in the same store on the same date) and compromised card number and the tally incremented appropriately. If there are more relevant files 323, NO-path—namely if there are more files associated with compromised cards in the set-of-interest 301, 303, 305 and in the date-range-of-interest 307—the next file is opened 309. Then, looking to decision block 321, YES-path, the iteration loop 315, following the NO-path, 311, 313, 317, 319, 321 is repeated until the last record—that is the last (rest, SID) pair of the last opened file—is analyzed, 323, YES-path. The process repeats for each compromised card. Programmers skilled in the art will recognize the efficiency benefits of performing these scans for all compromised cards at once, described hereinafter.

Once the last relevant file of the last compromised card has been analyzed 323, YES-path, merchant tallies can be compiled 325. An output 327 based upon the tallies is provided. The output 325 may be structured to fit any particular implementation. A tally descending-count ordered list would be a simple output based on the assumption that the merchant with the highest score has the highest probability of being the point-of-compromise.

There are a variety of data adjustment options which may be employed as part of compiling merchant tallies 325. For example, in order to better represent a final probability of point-of-compromise, normalization of each score, tally, can be implemented. For example, each tally may be normalized by the quantity of business each merchant transacts. Each tally entry is divided by the activity level of the merchant for the predetermined time period range-of-interest. Another exemplary factor may be merchant sales volume. It will recognized by those skilled in the art that such normalization, or other adjustment factors, for the data may be employed based upon the specific implementation and its related data domain knowledge.

Moreover, the tally compilation analysis may employ machine learning options. The tally feature of the process 300 may be used as an input which can feed back to and modify future compilation analyses. For example, given information of which merchants were found out to be an actual point-of-compromise by a prior analysis process 300, a labeled training set of merchants can be established. Known manner machine learning algorithms can use this unadjusted tally set as one potential predictive feature among others, such as transaction totals, sales volumes, and the like. A known manner machine learning component can then be trained to recognize merchants that match the determined pattern. This classifier, preferably providing a probability output, can be used, given the tally, to estimate which merchants are most likely points-of-compromise.

Other options are available for further refinement of the process 300. Each log period, e.g., each day, the matrix is updated as to correlated transactions. However, over time, merchants may merge, merchant identification codes may be recognized by Ajax Credit Co. as having been mistaken as distinct merchants but are actually a single entity, and the like. A relational adjunct database, e.g., an organization tree, can be maintained for referencing such new data correlating factors as each becomes recognized. The table is used when determining entities from SIDs.

Similarly, rather than storing individual merchant identifiers, Mₛ, in the preferred embodiments described above, an abstraction such as the transactions situation identification, SID, was employed. As part of the tally subprocess 325, a table can translate the abstraction back to a current definition of the merchant-of-interest. Storage of “hit” matrix data can then be reduced to only requiring the individual SIDs rather than each and every possible entity identifier, M.

As another option, note that once a tallying is established, at-risk credit cards may be predicted. A second indexed dataset, sorted by merchants having a relatively high probability of being a point-of-compromise can direct the issuer with respect to which Ajax credit cards should be the subject of an intensified watch for future fraudulent uses. In other words, given a list of most likely point-of-compromise merchants, the output can be a list of credit cards sorted by their score which can be traced to most likely at-risk customers. This may be used for example to notify such customers or to notify a plurality of other merchants to double-check identification on specific cards having an attempted use during a given time period.

As another option, a predetermined probability score can be associated with each merchant. When a merchant accepts a credit card and electronically transmits the credit card number for a dollar limit approval, a calculation can be quickly computed to determine the likelihood that the card is compromised. For example, the merchant may have a score normalized by transaction volume to represent a probability that a given credit card number is compromised. It is possible to either (1) simply filter the credit card list (FIG. 1) by a predetermined probability threshold, only selecting those merchants above a certain threshold, or (2) instead of tallying one full count for each cart transaction, accumulate the probability that the card has not been compromised. For example, this optional process would initialize the output scores to 1.0 for each credit card. When tallying a transaction between a given credit card, e.g., C_{H-1}, and a given merchant, M, who has a probability of compromising the card of 1%, multiplying the output probability by (100−1%=99%) determines the posterior probability that the card has not be compromised. The cards with the smallest output probability are the ones that are least likely not compromised and therefore represent the most at-risk transactions. Again, the merchant can be notified of the risk in the current transaction and security precautions can be implemented in real-time.

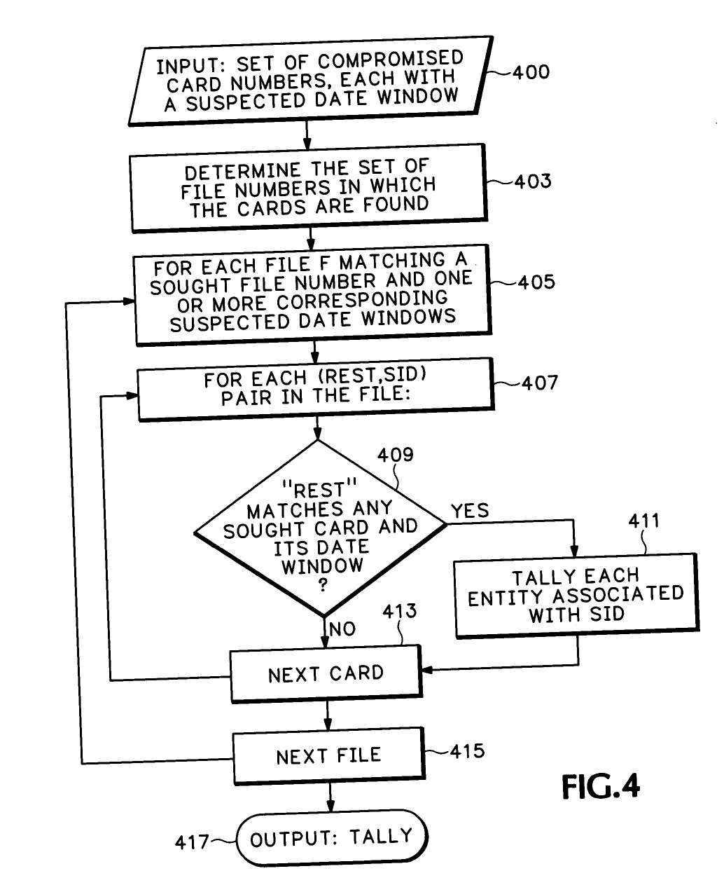

FIG. 4 represents the process described hereinbefore in a generic manner suited to computerized implementation. It assumes a company has maintained files for each identifiable item—in this exemplary embodiment still using credit cards as items being tracked for each use thereof. A computer program in accordance with this algorithm can be commercialized via known manner commercial distribution to be used by a credit processing company or its business agent(s).

The input 400 for this data mining, knowledge discovery, processing algorithm is a set of compromised identifiable items—e.g., credit card numbers—wherein each has a suspected date window—a search parameter defining a reasonable past time period before a given time-of-first-known-fraud. The term “card” and “product” or “equipment” and the like, or simply “item,” are thus interchangeable depending on the implementation design goals.

A set of file numbers in which there will be found compromised items is determined 403. Those files extracted for analysis of the contained data, namely a matrix of transactions for a given time period.

For each extracted file “f” matching a determined file number and for one or more corresponding suspected date windows 405, and for each (rest, SID) pair, supra, in the file 407, the “rest” is compared to any compromised card number and its date window 409.

That is, the first extracted file, “f 1,” first record, “rest₁, SID₁,” is analyzed. If there is a match, 409, YES-path, a tally is started, or incremented appropriately, for the associated SID.

The next 413 (rest, SID) pair 407 is then compared, tallying 411 only those SIDs where a match 409, YES-path, is determined.

When there are no more matches, 409, NO-path, in the current file, “f1,” then the next compromised card is similarly analyzed 407, 409, 411, 413.

When all of the compromised cards have been checked, the next file is opened 415, 405 and the process 407, 409, 411, 413, 415 is repeated.

Once all compromised cards in their respective date windows have been processed, the tally for each SID is output 417. As with the foregoing detailed description with respect to FIGS. 1, 2 and 3, the score for each SID is an indicator of likelihood of point-of-compromise.

Note that with this generic process, many techniques for data processing and filtering of data files may be employed. The storage saving by card number data compression has been described above is only one such technique. Similarly, other factors for normalization and indexing may be employed.

As described hereinabove with respect to various embodiments, the present invention thus relates to data mining and knowledge discovery techniques. The technique may be used by an individual entity or a group of entities organized for the purpose. A data base is established in a virtual matrix form for each transaction of large scale transactional events. Data is filed and logged in a manner for rapid sorting such that given a set of identifiers for comprised transactions, a limited subset of the matrix only need be accessed for specific knowledge discovery in the nature of point-of-compromise. For each potential point-of-compromise, a tally is compiled. Potential points-of-compromise are sorted according to tally score. Score is indicative of increasing likelihood of a source point-of-compromise.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. Credit card transactions, debit card transactions, or other large scale transactional payment surrogates, mass piece part manufacture with global distribution, consumables such as sterile medical and surgical supplies, and the like, all can be adapted to implementations of the present invention for data mining and knowledge discovery. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements during the term of the patent, and that adaptations in the future may take into consideration those advancements, in other word adaptations in accordance with the then current state of the art. It is intended that the scope of the invention be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .” What is claimed is:

1. A method for predicting potential points-of-compromise, the method comprising:
storing a database correlating each first member of a first set, wherein each of said first members may be compromised in time, with each second member of a second set, wherein each of said second members may be a potential point-of compromise;
recording in said database each interaction of a first member with a second member;
from a given third set of third members, wherein each of said third members is a given compromised first member, from said database, selecting each interaction associating said third members and said second members;
calculating an interaction factor for each of said third members from each said interaction; and
predicting at least one potential point-of-compromise from results of said calculating.

2. The method as set forth in claim 1 said selecting further comprising:
for each of said third members, including each said interaction found for a predetermined past time period.

3. The method as set forth in claim 2 wherein each said predetermined past time period is determined individually from a given time-of-first-know-fraud for each of said third members.

4. The method as set forth in claim 3 wherein said storing and said recording further comprises:
dividing said database into a plurality of separately retrievable files wherein each of said files is characterized by a predetermined time frame bounding interactions between said first members and said second members.

5. The method as set forth in claim 4 wherein for each of said third members said each said time-of-first-known-fraud and said predetermined time frame is used to filter out those separately retrievable files not within said predetermined past time period from said selecting.

6. The method as set forth in claim 4 wherein said separately retrievable files are created using identifier features of said second members suited to maximizing data compression.

7. The method as set forth in claim 1, said storing further comprising:
segregating correlated first members and second members into a plurality of data files wherein said files are identifiable via a predetermined common characteristic of at least one predetermined particular characteristic of a selected on of said first members or said second members.

8. The method as set forth in claim 7 wherein said segregating further comprises:
creating two-hundred-fifty-six files.

9. The method as set forth in claim 1, said predicting further comprising:
listing all second members associated in said selecting as a potential point-of-compromise with a score based upon a tally of interactions between said third members and said second members.

10. The method as set forth in claim 9, said predicting further comprising:
adjusting each said score by a common factor associated with each said second member associated in said selecting wherein all scores are normalized.

11. A method for identifying possible points-of-compromise, the method comprising:
creating a matrix correlating a plurality of at least two identifiers;
logging in said matrix every interactivity involving individual ones of each of said two identifiers;
from a given set of first specific identifiers, extracting from said matrix all interactivities with second identifiers for said set;
tabulating extracted said interactivities according to frequency of said interactivities; and
assigning a point-of-compromise score to each of said first identifiers wherein each said score is indicative of frequency of the extracted interactivities.

12. The method as set forth in claim 11 further comprising:
sorting said matrix into a plurality of data files such that in each of said files one of said identifiers has a predetermined unique characteristic; and
using a given identifier having said characteristic, retrieving from one of said files associated with said characteristic, each second identifier from said matrix having at least one of said interactivities.

13. The method as set forth in claim 11 further comprising:
limiting said extracting to a predetermined past time frame.

14. The method as set forth in claim 12 wherein each of said files is associated with a common structure or characteristic of at least one of said identifiers.

15. The method as set forth in claim 11 wherein each said interactivity is a data pair further comprising a fixed first identifier representative of a compromised identifier and an interactivity situation identifier.

16. The method as set forth in claim 15 wherein one particular interactivity identifier comprises one or more potential point-of-compromise identifiers.

17. A data storage and data mining process for determining at least one probable point-of-compromise for members of a data set, the process comprising:
in a set of data files, logging every individual transaction between first members and second members, wherein said first members are subject to compromise and said second members are each a potential point-of-compromise;
from a given set of compromised first members, segregating a subset of the data files for a predetermined time period past wherein said subset has at least one of said first members logged therein;
for each of said second members in said subset, incrementing a separate second member tally for each said individual transaction associated with each one of said compromised first members, creating a set of tallies associated with each of said second members; and
organizing said set of tallies according to a predetermined scoring statistic associated with probability of point-of-compromise.

18. A data storage and data mining system for determining at least one probable point-of-compromise for members of a data set, the system comprising:
means for storing data files;
means for logging in said data files every individual transaction between first members and second members, wherein said first members are subject to compromise and said second members are each a potential point-of-compromise;
from a given set of compromised first members, means for segregating a subset of the data files for a predetermined time period past wherein said subset has at least one of said first members logged therein;
for each of said second members in said subset, means for incrementing a separate second member tally for each said individual transaction associated with each one of said compromised first members and for creating a set of tallies associated with each of said second members; and
means for organizing said set of tallies according to a predetermined scoring statistic associated with potential as a point-of-compromise.

19. A method of determining credit card fraud point-of-compromise scores, the method comprising:
correlating all issued credit cards with all authorized points-of-use such that every transaction involving use of a credit card is retrievably logged in a database;
from a given set of compromised credit cards, extracting from said database all transactions involving use of each of said compromised credit cards;
for each of said authorized points-of-use involved in at least one of said transactions involving at least one of said compromised credit card, creating a tally of said transactions for each point-of-use, incrementing each said tally for each occurrence of transaction involving at least one of said compromised credit cards;
sorting said authorized points-of-use having a tally according to tally score; and
assigning a score representative of point-of-compromise likelihood to each of said authorized points-of-use having a tally according to said tally score.

20. The method as set forth in claim 19 wherein said extracting is limited to a predetermined time period range of past transactions.

21. The method as set forth in claim 19 wherein each said tally score is normalized via a characteristic related to point-of-use.

22. The method as set forth in claim 19 wherein said database comprises a plurality of files wherein each of said files is characterized by a given time frame bounding said transactions logged.

23. The method as set forth in claim 22 wherein each of said plurality of files is sortable by identifier data representative of subsets of credit card numbers.

24. The method as set forth in claim 23 wherein said plurality of files includes 256 or 256ⁿ files sorted by said identifier data.

25. The method as set forth in claim 20 wherein said predetermined time period range of past transactions is based upon a given suspected time-of-compromise window prior to a time-of-first-known-fraud for each said credit card.

26. The method as set forth in claim 22 wherein said files comprise a matrix of data compressed identifier pairs wherein each of said pairs includes a credit card identifier and a point-of-use situation identifier.

27. The method as set forth in claim 26 wherein a first database comprises a relational data pair relating said point-of-use situation identifier and said credit card identifier and a second database correlating each said point-of-use situation identifier to a physical said point-of-use.

28. A method of doing business comprising:
receiving a set of credit card numbers and a set of merchants authorized to accept said credit cards;
forming a matrix of said numbers and said merchants;
logging each use of a card with a merchant as a predetermined data point of said matrix;
from a given set of compromised credit card numbers, extracting therefor over a predetermined given time period, each related said data point of said matrix;
incrementing a tally for each merchant associated with each related said data point;
sorting said merchants by tally score; and
assigning a probability of point-of-compromise for said list of compromised credit card numbers based on said tally score.

29. A computer memory comprising:
computer code for compiling a database wherein members of a first class are associated with members of a second class in accordance with each interaction of a member of the first class with a member of the second class;
computer code for extracting from said database only those interactions for a predetermined past time period associated with a given subset of members of the first class wherein said given subset represents individual compromised members of said first class; and
computer code for assigning a score to individual members of the second class for each of said interactions extracted wherein said score represents a point-of-compromise probability for each of said individual members of the second class.

30. Given a computerized matrix of interactivity events between items-of-use, each having a unique first identifier, and points-of-use, each having a unique second identifier, and a set of compromised said items-of-use, wherein said matrix further comprises a plurality of files, each of said files covering a given time frame for said interactivity events, a method for point-of-compromise scoring comprising:
determining a time-of-first-known-fraud for each said compromised said items-of-use;
for each said compromised said items-of-use, assigning a suspected date window prior to said time-of-first-known-fraud;
selecting those ones of said files included in said suspected date window wherein said compromised said items-of-use are included in said files;
for each selected file and for each compromised said items-of-use, counting the number of said interactivity events for each of said points-of-use in each said selected file; and
assigning the highest score indicative of point-of-compromise to a highest scoring one of said points-of-use.
